(19) United States
(12) Patent Application Publication
(10) Pub. No.: US 2025/0363835 A1
(43) Pub. Date: Nov. 27, 2025

(54) Method for Adaptive Utilization of Road Surface Information, and System and Device Supporting Same

(71) Applicant: SK Planet Co., Ltd., Seongnam-si (KR)

(72) Inventor: Jonghee JUNG, Yongin-si (KR)

(21) Appl. No.: 19/292,762

(22) Filed: Aug. 6, 2025

Related U.S. Application Data
(63) Continuation of application No. PCT/KR2024/002558, filed on Feb. 28, 2024.

(30) Foreign Application Priority Data
Feb. 28, 2023 (KR) 10-2023-0027234

(51) Int. Cl. G07C 5/00; G06F 16/29

(52) U.S. Cl. CPC G07C 5/008; G06F 16/29

(57) ABSTRACT

The present invention relates to the adaptive utilization of road surface information. The system comprises at least one of an information distribution device or an information processing device. The information distribution device collects vehicle information from vehicles traveling a pre-identified infrastructure deficient section in which the amount of road surface detection information collected about a road is not greater than a preset reference amount, and the information processing device determines the road surface condition of the infrastructure deficient section on the basis of the vehicle information provided by the information distribution device, detects the level of travel risk for each vehicle type with respect to the determined road surface condition, generates a warning message for safe driving according to the detected level of travel risk for each vehicle type, and provides the warning message and road surface information to the vehicle via the information distribution device.

### CROSS-REFERENCE TO RELATED APPLICATIONS

This is a bypass continuation of International PCT Application No. PCT/KR2024/002558, filed on Feb. 28, 2024, which claims priority to Republic of Korea Patent Application No. 10-2023-0027234, filed on Feb. 28, 2023, which are incorporated by reference herein in their entirety.

### TECHNICAL FIELD

The present invention relates to the collection and adaptive utilization of road surface information, and more particularly, to a method for adaptive utilization of road surface information and a system and device supporting the same, which may provide safer vehicle driving guidance through comprehensive collection and analysis of road surface information.

### BACKGROUND ART

Information regarding road surface states during adverse weather such as hydroplaning, freezing, and snowfall typically plays a crucial role in efficient road management and traffic safety. Recently, accidents caused by black ice (or clear ice) have frequently occurred. Black ice refers to a phenomenon where a thin layer of ice forms on the road surface, appearing like a coating. This includes a phenomenon where snow and moisture mix with airborne pollutants and dust, seep into the gaps of the asphalt surface, and then freeze into a black layer. It mainly forms in shady and low-temperature places such as bridges, tunnel entrances and exits, shaded roads, and shady corners of mountains in the cold winter. Accordingly, monitoring road surface states like black ice, which may cause serious damage to vehicle driving, and providing alerts for such conditions are becoming increasingly important.

Typical road surface state management utilizes equipment called a road weather information system (RWIS), which is a system that predicts road surface and atmospheric conditions using data from a weather observation system, and provides prediction information. This road weather information system provides measured weather data and road surface state information in real time, thereby providing information for drivers to drive safely and providing road operators with efficient decision-making information regarding road management. However, these road weather information systems are difficult to deploy on all roads due to the very high costs of equipment installation and maintenance. Consequently, there is a problem of insufficient infrastructure for road monitoring in some areas. As such, it is difficult to monitor and observe all roads using road weather information systems alone. Therefore, a more realistic and continuous system for collecting and utilizing information on road surface states is required.

### SUMMARY

The present invention is intended to provide a method for adaptive utilization of road surface information, which collects the road surface information through various routes and adaptively utilizes the collected information according to a situation, and a system and device supporting the same.

A method for adaptive utilization of road surface information according to the present invention includes, at a server processor of an information distribution device, collecting vehicle information including vehicle outside temperature and friction value of wheels on a road surface; at the server processor, obtaining a road surface determination model by vehicle type based on the vehicle information; at the server processor, distributing the road surface determination model by vehicle type to each vehicle by vehicle type; at the server processor, receiving road surface information determined based on the road surface determination model by vehicle type from a vehicle driving on a road; and at the server processor, applying the road surface information to geographic information system (GIS) information.

Specifically, the method may further include, at the server processor, identifying a current location of the vehicle after receiving the road surface information; and in case that the current location of the vehicle is in a pre-designated infrastructure deficient section, applying the road surface information to the GIS information.

Specifically, obtaining may include providing the vehicle information to an information processing device; and receiving the road surface determination model by vehicle type generated by the information processing device based on the vehicle information.

Specifically, applying the road surface information to the GIS information may include, at the server processor, generating the GIS information in which a dangerous section is applied differently by vehicle type.

Specifically, the method may further include, at the server processor, distributing the GIS information with the dangerous section applied differently by vehicle type to each vehicle type differently.

An information distribution device for supporting adaptive utilization of road surface information according to an embodiment of the present invention includes a server communication circuit forming a communication channel with at least one vehicle, and a server processor functionally connected to the server communication circuit. The server processor is configured to distribute road surface determination models by vehicle type differently to each vehicle by vehicle type, the road surface determination model by vehicle type allowing a road surface state to be determined according to vehicle type based on vehicle information including at least one of vehicle outside temperature and friction value of wheels on a road surface, and upon receiving road surface information determined based on the road surface determination model by vehicle type from a vehicle currently driving on a road, apply the road surface information to geographic information system (GIS) information.

Specifically, the sever processor may be configured to provide the vehicle information to an information processing device, and receive the road surface determination models by vehicle type generated based on the vehicle information from the information processing device.

Specifically, the sever processor may be configured to receive current location information of the vehicle that provides the road surface information, in case that a current location of the vehicle is in a pre-designated infrastructure deficient section, apply the road surface information provided by the vehicle to the GIS information, and in case that the current location of the vehicle is in a pre-designated infrastructure sufficient section, update the GIS information by referring to the road surface information provided by the vehicle based on the pre-stored road surface information.

Specifically, the sever processor may be configured to generate the GIS information in which a dangerous section is indicated differently by vehicle type, based on the road surface information.

Specifically, the sever processor may be configured to distribute the GIS information with the dangerous section applied differently by vehicle type to the vehicle differently by vehicle type.

An information processing device for supporting adaptive utilization of road surface information according to an embodiment of the present invention includes a communication circuit and a processor. The processor is configured to, for a pre-designated infrastructure deficient section where an amount of road surface detection information collected about a road is not greater than a preset reference, collect vehicle information from vehicles driving in the infrastructure deficient section, determine a road surface state of the infrastructure deficient section based on the collected vehicle information, detect a driving risk level by vehicle type in the determined road surface state, generate a warning message for safe driving based on the detected driving risk level by vehicle type, and transmit the warning message and road surface information including the road surface state to the vehicle.

A system for adaptive utilization of road surface information according to an embodiment of the present invention includes an information distribution device that collects vehicle information from vehicles driving in a pre-designated infrastructure deficient section where an amount of road surface detection information collected about a road is not greater than a preset reference; and an information processing device that determines a road surface state of the infrastructure deficient section based on the vehicle information provided by the information distribution device, detects a driving risk level by vehicle type in the determined road surface state, generates a warning message for safe driving based on the detected driving risk level by vehicle type, and provides the warning message and road surface information including the road surface state to the vehicle via the information distribution device.

The present invention can support more efficient collection and utilization of road surface state information.

In addition, the present invention can collect information on various road surface states, produce the degree of risk occurrence by vehicle type or vehicle based on the collected road surface state information, and guide vehicles driving on a road with a specific road surface state according to the produced degree, thereby inducing safer driving.

In addition, various effects that can be provided by the present invention will be understood through embodiments described below.

### BRIEF DESCRIPTION OF DRAWINGS

FIG. 1 is a diagram illustrating an example of an adaptive utilization system of road surface information according to an embodiment of the present invention.

FIG. 2 is a diagram illustrating an example of the configuration of an information processing device according to an embodiment of the present invention.

FIG. 3 is a diagram illustrating an example of the configuration of an information distribution device according to an embodiment of the present invention.

FIG. 4 is a diagram illustrating an example of the configuration of a vehicle according to an embodiment of the present invention.

FIG. 5 is a diagram illustrating an example of a signal flow for the operation of an adaptive utilization system of road surface information according to an embodiment of the present invention.

FIG. 6 is a diagram illustrating an example of an information processing device operation method in an adaptive utilization method of road surface information according to an embodiment of the present invention.

FIG. 7 is a diagram illustrating an example of an information distribution device operation method in an adaptive utilization method of road surface information according to an embodiment of the present invention.

FIG. 8 is a diagram illustrating another example of an information distribution device operation method in an adaptive utilization method of road surface information according to an embodiment of the present invention.

FIG. 9 is an example diagram of a hardware system for implementing a device for adaptive utilization of road surface information according to an embodiment of the present invention.

### DETAILED DESCRIPTION

In order to clarify the features and advantages of the technical solution of the present invention, the present invention will be described in detail with reference to specific embodiments of the present invention illustrated in the accompanying drawings.

However, in the following description and the accompanying drawings, well known functions or elements may not be described or illustrated to avoid obscuring the subject matter of the present invention. Through the drawings, the same reference numerals denote the same elements as much as possible.

The terms or words used in the following description and drawings should not be interpreted as limited to their conventional or dictionary meanings, but should be interpreted as meanings and concepts that conform to the technical idea of the present invention based on the principle that the inventor can appropriately define the concept of terms to best describe his or her own invention. Therefore, the embodiments described in this specification and the configurations illustrated in the drawings are merely the most preferred embodiments of the present invention and do not represent all of the technical ideas of the present invention. Therefore, it should be understood that there may be various equivalents and modified examples that can replace them at the time of filing this application.

Additionally, the terms including ordinal numbers such as first, second, etc. indicating various elements are used for merely distinguishing one element from another and do not limit the corresponding elements. For example, without departing from the scope of the present invention, a second element may be referred to as a first element, and similarly, a first element may also be referred to as a second element.

Further, when it is mentioned that a particular element is “connected” or “coupled” to another element, it means that the particular element may be connected or coupled logically or physically to another element. That is, the particular element may be connected or coupled directly to another element, but there may also be any other element therebetween, and it may be connected or coupled indirectly.

In addition, the terms used herein are only to describe specific embodiments and are not intended to limit the present invention. The singular expression includes the plural expression unless the context clearly indicates otherwise. Also, the terms “comprise” or “include” used herein are intended to specify the presence of a feature, number, step, operation, element, component, or combination thereof, which is described herein, and should not be construed to preclude the presence or addition of one or more other features, numbers, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms may be used in the context of describing the present invention (especially in the context of claims below) to have both singular and plural meanings, unless otherwise indicated herein or clearly contradicted by context.

Also, embodiments within the scope of the present invention include a computer-readable medium having or sending computer-executable instructions or data structures stored therein. Such a computer-readable medium may be any available medium that is accessible by a general-purpose or special-purpose computer system. By way of example, such a computer-readable medium may include, but is not limited to, a RAM, a ROM, an EPROM, a CD-ROM or other optical disk storage, a magnetic disk storage or other magnetic storage device, or any other physical storage medium that can be used to store or deliver certain program codes formed of computer-executable instructions, computer-readable instructions or data structures and which can be accessed by a general-purpose or special-purpose computer system.

In the following description and claims, a “network” is defined as one or more data links that enable the transfer of electronic data between computer systems and/or modules. When information is transferred or provided to a computer system over a network or other (wired, wireless, or a combination thereof) communications connection, the connection can be understood as a computer-readable medium. Computer-readable instructions include, for example, instructions and data that cause a general-purpose or special-purpose computer system to perform a particular function or group of functions. Computer-executable instructions can be, for example, binary, intermediate format instructions, such as assembly language, or even source code.

In addition, the present invention may be applied in a network computing environment having various kinds of computer system configurations including personal computers, laptop computers, handheld devices, multiprocessor systems, microprocessor-based or programmable consumer electronics, network PCs, minicomputers, mainframe computers, mobile phones, PDAs, pagers, and the like. The present invention may also be implemented in a distributed system environment where both local and remote computer systems linked by a wired data link, a wireless data link, or a combination thereof through a network perform tasks. In such a distributed system environment, program modules may be located in local and remote memory storage devices.

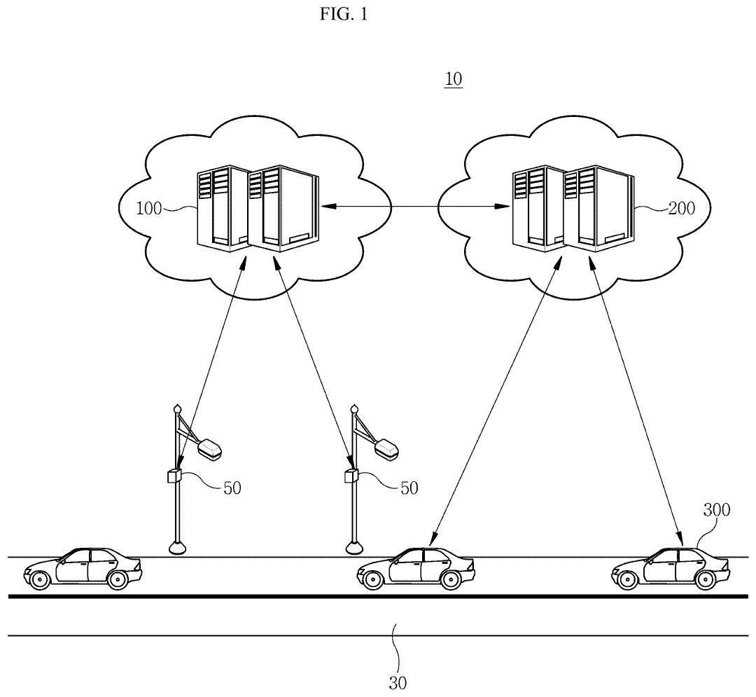

FIG. 1 is a diagram illustrating an example of an adaptive utilization system of road surface information according to an embodiment of the present invention.

Referring to FIG. 1, the adaptive utilization system 10 of road surface information according to an embodiment of the present invention may include a road 30, a road surface detection device 50, an information processing device 100, an information distribution device 200, and at least one vehicle 300 driving on the road 30.

The road 30 may be provided so that a plurality of vehicles 300 or at least one vehicle 300 can move. The surface of the road 30, i.e., the road surface, may have various states depending on weather conditions or various circumstances of the surrounding environment. For example, the road surface state of the road 30 may be a freezing state, a hydroplaning state, a snowfall state, etc. Or, the road surface of the road 30 may have a state in which at least a part is damaged, warped, or broken. Depending on such road surface states of the road 30, the risk level of the vehicle 300 driving on the road 30 may vary.

The vehicle 300 is configured to be able to run on the road 30, and may collect sensing information according to driving on the road 30 by including at least one sensor and transmit the collected sensing information to the information distribution device 200. In addition, the vehicle 300 may receive road surface information or a warning from the information distribution device 200 and output at least part of the received information. Additionally, the vehicle 300 may automatically reduce the speed or turn on the emergency lights based on the information received from the information distribution device 200.

The road surface detection device 50 may include a device arranged to collect information on the road surface of at least a section of the road 30. For example, the road surface detection device 50 may include at least one of an image sensor (or a spectral sensor) capable of photographing the road surface of the road 30 on which the vehicle 300 is driving, an audio collection sensor capable of collecting noise or audio signals that may occur on the road surface, and a temperature detection sensor capable of measuring the temperature of the road surface. The road surface detection device 50 may collect road surface detection information under the control of at least one of the information processing device 100 and the information distribution device 200, and provide the collected road surface detection information to at least one of the information processing device 100 and the information distribution device 200. The following description will be made based on the assumption that the information processing device 100 collects the road surface detection information by controlling the road surface detection device 50 and determine the road surface state based on the collected road surface detection information. However, the present invention is not limited thereto, and the road surface detection device 50 for collecting the road surface detection information may be controlled by the information distribution device 200, and the information distribution device 200 may be operated to provide the road surface detection information from the road surface detection device 50 to the information processing device 100. In this regard, the road surface detection device 50 may form a communication channel with the information processing device 100 through at least one base station, and perform reception of control information and transmission of road surface detection information through the base station. The road surface detection device 50 may also form a communication channel with the information processing device 100 or the information distribution device 200 based on at least one of wired communication and wireless communication without using the base station.

The information processing device 100 may form a communication channel with the road surface detection device 50, collect the road surface detection information periodically or in real time based on the occurrence of a predefined event, and determine the road surface state of the road 30 according to the collected road surface detection information. The information processing device 100 may include, for example, a device operated by a communication service provider (or mobile communication service provider) capable of operating at least one base station so as to form a communication channel with the road surface detection device 50. The information processing device 100 may perform checking the normal or abnormal state of the road surface detection device 50, controlling the operation of the road surface detection device 50, and controlling the collection of road surface detection information of the road surface detection device 50 through base station control. Each road surface detection device 50 may have a fixed location (alternatively, the road surface detection device 50 may be configured to move around a designated area), and thus, the information processing device 100 may collect location information of the road surface detection device 50 in advance and, based on the location information, check the state of the road 30 at a certain location in real time or at the time of occurrence of a designated event which.

In an example, when the weather condition is one of predefined conditions or when the road surface state condition is one of predefined conditions, the information processing device 100 may control the road surface detection device 50 to collect the road surface detection information. The weather condition may include, for example, at least one of a condition where the amount of rainfall or snowfall is greater than or equal to a reference value, a condition where fog or humidity is greater than or equal to a reference value, and a condition where the road temperature is less than or equal to a reference value. The road surface state condition may include at least one of a condition where the reflectivity of the road surface (or a friction value of the road surface) is greater than or equal to a reference value, a condition where a pothole or crack of a certain size or greater has occurred on the road surface, and a condition where a foreign substance of a certain size or greater is placed on the road surface. For determination of the road surface state condition, the road surface detection device 50 may obtain a preview image and transmit it to the information processing device 100, and the information processing device 100 may check the entire preview image or a preview image sampled from a certain section and determine the road surface state condition. Meanwhile, the information processing device 100 may operate at least one condition among the above-mentioned conditions for collecting the road surface detection information. For example, the information processing device 100 may vary the number of applicable conditions according to settings, situations, or requests from an administrator. Based on the road surface detection information, the information processing device 100 may process the creation and provision of road surface information for a designated area (e.g., an area monitored by the road surface detection device 50 or an area where the infrastructure for road surface detection is satisfied). The road surface detection information may include at least one piece of information for allowing the determination of a road surface state, such as a road surface photographed image, an audio signal generated from the road surface, the degree of light reflection of the road surface, and the color of the road surface, and reference values corresponding to specific road surface states may be pre-stored in a device that determines the road surface state.

The information processing device 100 may form a communication channel with the information distribution device 200 and receive vehicle information from the information distribution device 200. The information processing device 100 may extract vehicle sensing information from the received vehicle information and, based on the extracted vehicle sensing information, determine the road surface state of the road 30 on which the vehicle 300 is currently driving. The information processing device 100 may provide the information distribution device 200 with a determination result of the road surface state, for example, road surface information (e.g., information indicating whether the road surface state is a freezing state, a hydroplaning state, a snowfall state, or a state where there is a certain hole, crack, or foreign substance). In this process, the information processing device 100 may identify the vehicle type of the vehicle 300 and determine the level of risk in the current road surface state according to the vehicle type. If the risk level is higher than a reference value, the information processing device 100 may provide a warning message to the information distribution device 200 or directly to the vehicle 300. In relation to the above-described operation, the information processing device 100 may store and operate a learning model on driving risk by vehicle type according to the road surface state. The area where the road surface state is determined based on the vehicle information may include, for example, an area where the road surface detection device 50 is not disposed or an area where the infrastructure for road surface state analysis is insufficient.

The information distribution device 200 may collect at least one of road surface information based on road surface detection information and road surface information based on vehicle information and, based on the collected information, update geographic information system (GIS) information including information on road surface states. In this regard, the information distribution device 200 may collect vehicle information including at least an outside temperature of the vehicle 300 and a friction value of wheels on the road and, based on the vehicle information, obtain a road surface determination model by vehicle type. After distributing the road surface determination model by vehicle type to each vehicle 300, the information distribution device 200 may receive road surface information determined based on the road surface determination model by vehicle type from the vehicle driving on the road. Thereafter, the information distribution device 200 may apply the road surface information to the GIS information and provide it to an administrator.

The information distribution device 200 may obtain road surface information through various routes and adaptively utilize road surface information of various roads (or roads of the entire country) based on the obtained road surface information. In this regard, the information distribution device 200 may prepare a data sheet corresponding to a standardized form for road surface information standardization and provide the data sheet to at least one information processing device 100. For example, the information distribution device 200 may standardize at least one of an information transmission interfacing scheme, a communication protocol, and a road surface information entry scheme and communicate with the information processing device 100 and the vehicle 300 in a standardized scheme to collect and utilize road surface information and warning information. Through this, the information distribution device 200 may prevent duplicate production of road surface information while maximizing the utilization of road surface information.

The information distribution device 200 may belong to the national operation system according to the deployment location or characteristics and may be operated while equipped with a national road surface information platform. The national road surface information platform may include a platform provided to collect road surface information from at least one road surface information operation agency or department belonging to the country and manage the collected road surface information comprehensively. For example, the national road surface information platform may be provided by connecting at least one of a computing device operated by the Ministry of Public Administration and Security, a computing device operated by the Ministry of Land, Infrastructure and Transport, a computing device operated by the Disaster Management Department of the Korea Expressway Corporation, a computing device for operating the Intelligent Transport System (ITS), a computing device supporting the operation of local government ITS, and a computing device of a smart city promotion department as a module, and receiving road surface information from such computing devices to construct the entire road surface information of the country based on GIS information.

The above-described information distribution device 200 may generate a vehicle risk level detection model based on infrastructure information including at least one electronic device configured to collect vehicle information and road surface detection information, and process the provision of information necessary for safe driving of the vehicle based on the generated vehicle risk level detection model. In this operation, the information distribution device 200 may be configured to delegate the generation and operation of the vehicle risk level detection model to the information processing device 100 and perform at least some of tasks of collecting road surface detection information and distributing road surface information. In the adaptive utilization system 10 of the road surface information, when the information distribution device 200 is configured to generate the vehicle risk level detection model, the information distribution device 200 may support performing vehicle-to-infra (V2I) learning or infra-to-vehicle (I2V) learning. In this process, the information distribution device 200 may provide vehicle information (e.g., outside temperature, rain sensor, wheel rotation differential, friction) to an acoustic road surface detection system or road hazard notification service module (e.g., Audio & AI based Road Hazard Information System (ARHIS)) of the information processing device 100, perform deep learning with at least some of the vehicle information with reference to the ARHIS true value, and then provide the corresponding model by vehicle type after the learning is completed, thereby enabling the vehicle to independently determine the road surface state. Or, the information distribution device 200 may be configured to perform road hazard analysis based on vehicle information provided by the vehicle 300 for sections where infrastructure is insufficient, and perform road hazard analysis based on road surface detection information provided by the road surface detection device 50 without separate vehicle information for sections where infrastructure is sufficient. Through this, the information distribution device 200 may increase the resolution of road surface information or maximize the detection range of road hazard sections.

As described above, the adaptive utilization system 10 of road surface information according to the embodiment of the present invention can perform more stable and useful road surface state determination while minimizing the cost required for arranging equipment capable of collecting road surface detection information by deploying the road surface detection device 50 that can detect the road surface state by using an already established communication system, for example, a communication service provider operating base stations, more realistically in the process of collecting at least some of the road surface detection information and vehicle information, necessary for determining the road surface state, through various routes. In addition, the adaptive utilization system 10 of the present invention can support efficient road surface state determination and also reduce the risk of driving on the road 30 by the vehicle 300, by constructing a standardized information platform for adaptive utilization and integrated operation of road surface information, comprehensively collecting and integrating road surface information used by different departments, and providing it through GIS.

Furthermore, the adaptive utilization system 10 of road surface information according to an embodiment of the present invention can perform road surface determination modeling for each vehicle type based on friction information of the vehicle 300, generate and distribute road surface determination models by vehicle types, receive road surface state information (e.g., road surface information created by the vehicle) analyzed based on variation in friction during vehicle wheel rotation, and adaptively provide road surface information for at least some road sections (e.g., infrastructure deficient sections) based on this.

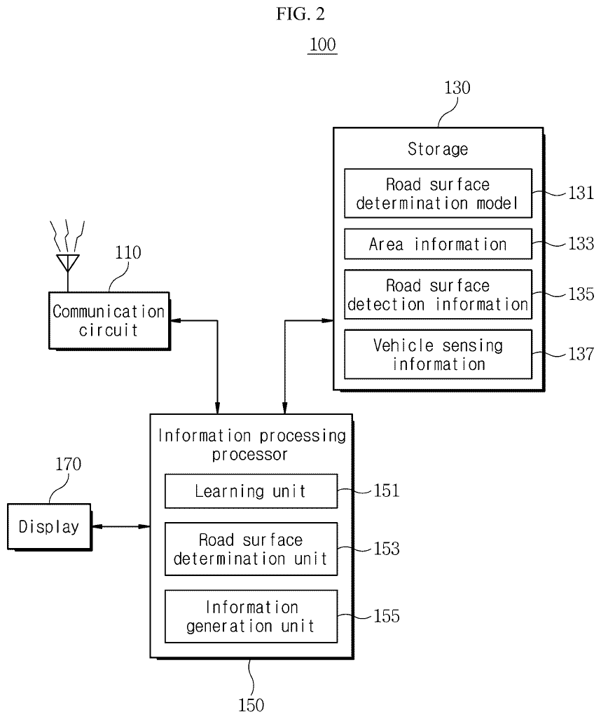

FIG. 2 is a diagram illustrating an example of the configuration of an information processing device according to an embodiment of the present invention.

Referring to FIG. 2, the information processing device 100 may include a communication circuit 110, a storage 130, a display 170, and an information processing processor 150. The information processing device 100 may include a device operated by a communication service provider that may form a communication channel with the road surface detection device 50 through at least one base station.

The communication circuit 110 may form a communication channel with the road surface detection device 50. In this process, the communication circuit 110 may form a long-distance wireless communication channel with the road surface detection device 50 through the base station. In this regard, the communication circuit may include a circuit and antenna capable of supporting at least one communication scheme among various communication schemes such as 3G, 4G, and 5G. The communication circuit 110 may not only transmit control information to the road surface detection device 50 in response to the control of the information processing processor 150, but also receive road surface detection information from the road surface detection device 50 and deliver it to the information processing processor 150.

The storage 130 may store at least one program and transmitted/received data required for the operation of the information processing device 100. For example, the storage 130 may store a road surface determination model 131, area information 133, road surface detection information 135, and vehicle sensing information 137. The road surface determination model 131 may include a model generated by performing deep learning on at least one of the area information 133, the road surface detection information 135, and the vehicle sensing information 137. For example, the road surface determination model 131 may include at least one road surface model from among a freezing determination model, a hydroplaning determination model, a snowfall determination model, a pothole determination model, a crack determination model, and a foreign substance determination model, which are generated based on at least some of the road surface detection information 135 and the vehicle sensing information 137 and are used to determine the road surface state. In addition, the road surface determination model 131 may include a vehicle risk detection model that calculates the risk level of the vehicle 300 driving on a road surface. The vehicle risk detection model may be a model that learns which vehicle types in which states have difficulty in normal driving or have a possibility of risk occurring during driving, for road surface models in various states. The vehicle risk detection model, which varies in weight, tire grip, steering control, and deceleration control by vehicle types, may be generated based on various experimental data and statistical data by road surface states.

The area information 133 may include information for mapping the road surface detection information 135 and the vehicle sensing information 137 to the area where such information is collected. The information processing processor 150 may periodically collect information on an area having a specific road surface state (e.g., a freezing state, a hydroplaning state, a snowfall state) based on the area information 133 and provide it to the information distribution device 200. The area information 133 may include information on the locations where the road surface detection devices 50 are placed. The area information 133 may include information on an area monitored by the road weather information system, an area monitored by the road surface detection device 50, a satisfactory area (or an infrastructure sufficient section) where the infrastructure satisfies a designated condition, an unsatisfactory area (or an infrastructure deficient section) where the infrastructure does not satisfy a designated condition, etc.

The road surface detection information 135 may include sensing information collected from the road surface detection device 50 installed on the road 30. The road surface detection information 135 may be collected periodically or in real time. Alternatively, when a particular event (e.g., a specific weather condition) occurs, the road surface detection information 135 may be collected in response to the control of the information processing processor 150. In this regard, the information processing processor 150 may form a communication channel with an external electronic device (or an external server device) that provides weather information periodically or in real time, and may control the road surface detection device 50 to collect the road surface detection information 135 for a specific area when the weather in the specific area deviates from a predefined condition.

The vehicle sensing information 137 may include at least some of sensing information provided by the vehicle driving on the road 30. The vehicle sensing information 137 may include, for example, at least some of vehicle information collected from the vehicle 300 by the information distribution device 200. The vehicle sensing information 137 may include at least one of a driving speed of the vehicle 300, location information of the vehicle 300, information on road images taken around the vehicle 300 by the vehicle 300 (e.g., at least one of an RGB image, a spectral image, and a thermal image), an outside temperature of the vehicle 300, a wind speed, illuminance information, and vehicle type information of the vehicle 300, as sensing information collected by the vehicle 300 driving on the road 30.

The display 170 may output at least one screen related to the operation of the information processing device 100. For example, the display 170 may output a screen related to receiving the road surface detection information 135 and the vehicle sensing information 137, a screen related to the process of generating the road surface determination model 131 based on the received road surface detection information 135, vehicle sensing information 137, and area information 133, a screen related to the operation of the generated road surface determination model 131, etc. The display 170 may be omitted or replaced with another device (e.g., at least one communication and information output device that is functionally connected to the information processing device 100 and receives a screen related to the operation of the information processing device 100).

The information processing processor 150 may control at least one of receiving, transmitting, and storing a signal necessary for the operation of the information processing device 100. For example, the information processing processor 150 may perform at least one operation related to road surface determination and vehicle risk determination. In this regard, the information processing processor 150 may include a learning unit 151, a road surface determination unit 153, and an information generation unit 155.

The learning unit 151 may generate the road surface determination model 131 through deep learning. In this regard, the learning unit 151 may collect the road surface detection information 135 and the vehicle sensing information 137 sufficient to generate a road surface model for a specific area based on the area information 133. The learning unit 151 may perform AI modeling to generate a road surface model when at least some of the stored road surface detection information 135 and vehicle sensing information 137 are accumulated to a predetermined amount or more. For example, the learning unit 151 may accumulatively collect a certain amount of the road surface detection information 135 for a specific area based on the area information 133, and then generate at least one road surface model among a freezing determination model, a hydroplaning determination model, a snowfall determination model, a pothole determination model, a crack determination model, and a foreign substance determination model for the specific area based on the collected information. In another example, the learning unit 151 may generate a road surface model using only the vehicle sensing information 137 for an area where there is no road surface detection information 135.

In addition, the learning unit 151 may generate a vehicle risk detection model based on the road models and the vehicle sensing information 137. Alternatively, the learning unit 151 may receive data from experiments conducted by a nationally designated company on various vehicle types in various road model states described above, and generate a vehicle risk detection model for each road model based on the received data. Meanwhile, the adaptive utilization system 10 of road surface information according to the embodiment of the present invention has been described in which the information processing device 100 generates the road determination model 131, but the present invention is not limited thereto. For example, the road determination model 131 may be generated by a separate external electronic device or the information distribution device 200 and provided to the information processing device 100.

The road surface determination unit 153 may determine the road surface state at the current time based on at least one of the currently received road surface detection information and vehicle sensing information. In this regard, the road surface determination unit 153 may detect the closest road surface model by applying at least some of the currently received road surface detection information and vehicle sensing information to road surface models, and may detect the risk level of the corresponding vehicle by applying vehicle type information to the detected road surface model. The road surface determination unit 153 may transmit the vehicle risk level to the information generation unit 155.

The information generation unit 155 may create a warning message or create GIS update information according to the vehicle risk level received from the road surface determination unit 153 and provide it to the information distribution device 200. In another example, the information generation unit 155 may directly provide the warning message to the vehicle 300 without transmitting it to the information distribution device 200. Meanwhile, the information generation unit 155 may enter road surface information in accordance with the standardized road surface information form defined by the information distribution device 200 and provide the road surface information to the information distribution device 200.

The information processing device 100 described above may analyze a road surface state based on road surface detection information for an area where the road surface detection information is collected, and may analyze a road surface state based on vehicle sensing information for an area where the road surface detection information is not collected. In addition, the information processing device 100 may perform more accurate road surface state analysis by integrating related information in an area where both the road surface detection information and the vehicle sensing information are collected.

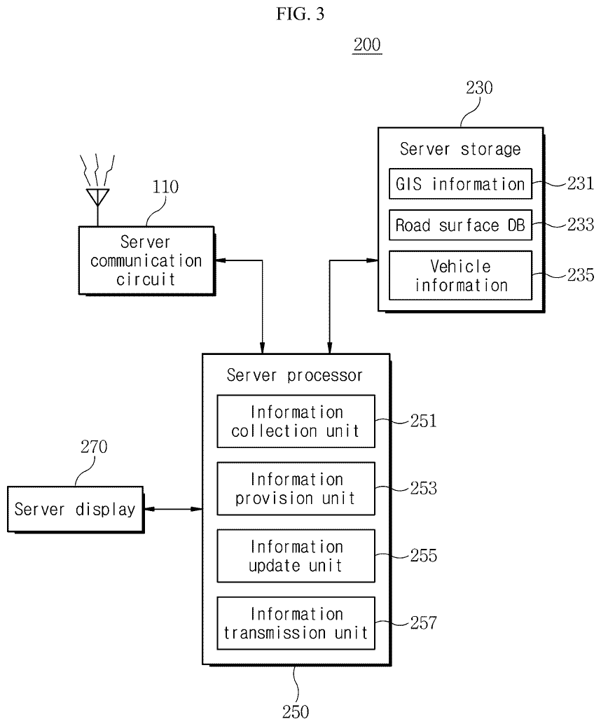

FIG. 3 is a diagram illustrating an example of the configuration of an information distribution device according to an embodiment of the present invention.

Referring to FIG. 3, the information distribution device 200 may include a server communication circuit 210, a server storage 230, a server display 270, and a server processor 250. The server display 270 may be optionally omitted.

The server communication circuit 210 may support the information distribution device 200 to form a communication channel and transmit/receive data. For example, the server communication circuit 210 may form a communication channel with at least one of computing devices of a road weather information system, ITS, local government ITS, and other authorized or unauthorized organizations capable of providing road surface information, and may collect road surface detection information of each area through the communication channel. The server communication circuit 210 may provide the collected road surface detection information for each area to the information processing device 100 in response to the control of the server processor 250, and may receive road surface information of the corresponding area (e.g., information indicating whether a road in a specific area is in a freezing state or a hydroplaning state, etc.) from the information processing device 100. The server communication circuit 210 may transmit the received road surface information to a designated vehicle 300. In addition, the server communication circuit 210 may provide a warning message to the vehicle 300 in response to the control of the server processor 250. The format of data transmitted and received by the server communication circuit 210 may include a standardized format predefined for checking road surface information.

The server storage 230 may store at least one piece of information necessary for the operation of the information distribution device 200. For example, the server storage 230 may include geographic information system (GIS) information 231, road surface database (DB) 233, and vehicle information 235. The GIS information 231 may include information on the locations, lengths, shapes, etc. of roads installed in a certain country, city, region, etc. The road surface DB 233 can include road surface information indicating the current road surface state of each region included in the GIS information 231. The vehicle information 235 may include information indicating which vehicle 300 is driving on which region's road and sensing information provided by the vehicle 300.

The server display 270 may output at least one screen related to the operation of the information distribution device 200. For example, the server display 270 may provide a screen that allows searching for the road surface state of a certain area. In addition, the server display 270 may provide a screen that shows which vehicle is driving in a certain area. The server display 270 may output alarm information on the vehicle 300 that has a risk level higher than a certain reference value.

The server processor 250 may control at least one operation among transmission, processing, and storage of signals required for the operation of the information distribution device 200. For example, the server processor 250 may control the transmission/reception and storage of standardized road surface information, the utilization of stored road surface information (e.g., generation and operation of a learning model), and the collection and operation of the vehicle information 235. In this regard, the server processor 250 may include an information collection unit 251, an information provision unit 253, an information update unit 255, and an information transmission unit 257.

The information collection unit 251 may collect road surface detection information in various areas. For example, the information collection unit 251 may collect the road surface detection information from various ministries or departments that are operated by a country or a specific organization to collect and utilize information on road surfaces. In this process, the information collection unit 251 may standardize the collected road surface information according to a predefined standard and store it as the road surface DB 233 in the server storage 230. Meanwhile, the information collection unit 251 may utilize the GIS information 231 and the road surface DB 233 to distinguish between an area where the road surface analysis accuracy or the infrastructure construction is higher than a predefined reference value or an area where it is not. In this process, if several pieces of road surface detection information are collected in duplicate for one area, the information collection unit 251 may be configured to collect only the road surface detection information from a device (or a computing device of the department or ministry) that provides the road surface detection information with the highest reliability for the area, and ignore the remaining information. Alternatively, the information collection unit 251 may be configured to apply weights to several pieces of road surface detection information for one area to enable road surface state detection with higher accuracy.

The information provision unit 253 may provide the road surface detection information collected from each department to the information processing device 100 and receive road surface information from the information processing device 100. Or, the information provision unit 253 may request the information processing device 100 to provide related road surface information for an infrastructure deficient section. The information processing device 100 may collect road surface detection information using the road surface detection device 50 installed in the infrastructure deficient section and provide road surface information determined based on the road surface detection information to the information provision unit 253. On the other hand, the information provision unit 253 may request the vehicle information 235 from the vehicle 300 driving in the infrastructure deficient section and provide the information processing device 100 with the vehicle information 235 collected in response to the request. The information processing device 100 may determine the road surface state of the infrastructure deficient section based on the vehicle information 235 and provide road surface information corresponding to the determination result to the information provision unit 253. The road surface information may include at least some of information on the road surface state and information on the risk level of each vehicle type according to the road surface state.

The information update unit 255 may update the road surface DB 233 based on the road surface information received from the information processing device 100. The road surface DB 233 may be stored in connection with the GIS information 231. Accordingly, the information update unit 255 may update an area having a road surface state (e.g., a freezing state, a hydroplaning state, a snowfall state, a pothole or crack state, a foreign substance state) exceeding a predefined reference in real time or according to the occurrence of a specific weather event, and may output the updated information through the server display 270. The information update unit 255 may also output information on driving risks by vehicle type depending on a specific road surface state to the server display 270.

The information transmission unit 257 may receive information on driving risks by vehicle type for an area with a specific road surface state from the information update unit 255. The information transmission unit 257 may identify the vehicle type of the vehicle 300 driving in a specific area through the vehicle information 235 and provide a warning message based on the vehicle type. The information transmission unit 257 may provide different warning messages for different vehicle types driving in an area with the same road surface state. For example, the information transmission unit 257 may transmit a first warning message warning to maintain a first speed range for a vehicle with a relatively high steering control (e.g., torque vectoring control) level of the vehicle 300 (or a vehicle above a specified reference), and may transmit a second warning message warning to maintain a second speed range (e.g., a speed range lower than the first speed range) for a vehicle with a relatively low steering control level of the vehicle 300 (or a vehicle below a specified reference). Additionally, the information transmission unit 257 may transmit different warning messages depending on additional information identified in the vehicle information 235, such as the total driving distance of the vehicle, the total driving time of the vehicle, the driving experience of the vehicle driver, the number of passengers, etc.

The server processor 250 may receive the vehicle information including GPS information, rain sensor information, friction information, and outside temperature information of the vehicle 300 from various vehicles, and perform road surface determination modeling by vehicle type using the received vehicle information. Alternatively, the server processor 250 may request the information processing device 100 to generate a road surface determination model by vehicle type and obtain it. The server processor 250 may divide and distribute the road surface determination models by vehicle type, and upon receiving road surface information for a specific area using the road surface determination model from each vehicle, may apply it to the GIS information. In this process, the server processor 250 may distribute the GIS information divided by vehicle type differently by vehicle type. Accordingly, each vehicle may receive and output the GIS information in which a dangerous section is indicated differently by vehicle type.

In relation to the operation of the road surface determination model by vehicle type and the generation and distribution of the GIS information by vehicle type as described above, the server processor 250 may perform the above-described operation for a section with relatively insufficient infrastructure. Also, for a section with sufficient infrastructure, the server processor 250 may analyze the road surface state using the road surface detection information and utilize the road surface information provided by the vehicle 300 as reference information.

Meanwhile, in the above description of the information processing device 100, the information processing processor 150 is described exemplarily as determining a road surface by generating the road surface determination model 131, but the present invention is not limited thereto. The information distribution device 200 may directly generate a road surface determination model based on the collected information and use the generated road surface determination model to determine the road surface state and detect the vehicle risk level.

As described above, the information distribution device 200 according to the embodiment of the present invention not only standardizes the road surface information and the communication environment of road surface information transmission and reception devices to support common operation of road surface information in various departments and ministries, but also adaptively process differences in the amount of road surface detection information for determining the road surface state in each area to support optimal road surface state determination and stable vehicle driving guidance, thereby reducing the occurrence of vehicle 300 accidents and inducing safe driving.

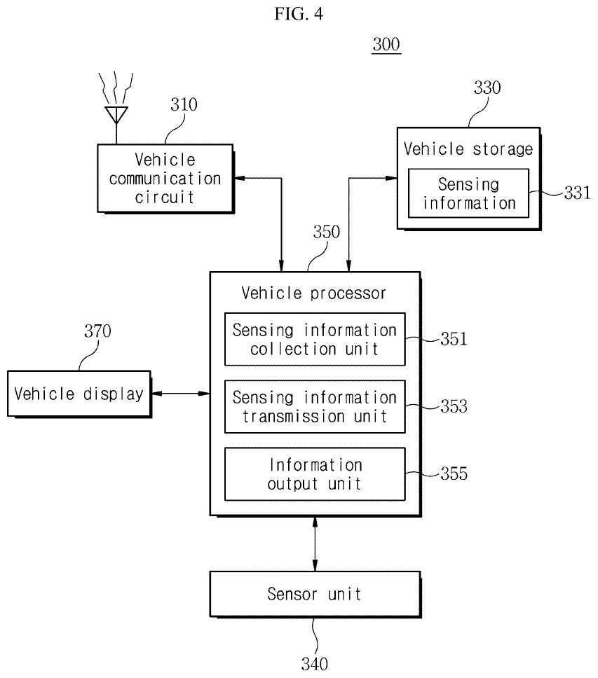

FIG. 4 is a diagram illustrating an example of the configuration of a vehicle according to an embodiment of the present invention.

Referring to FIG. 4, the vehicle 300 may include a vehicle communication circuit 310, a vehicle storage 330, a vehicle display 370, a sensor unit 340, and a vehicle processor 350. In addition, the vehicle 300 may further include at least some of devices for driving on the road 30 (e.g., a plurality of wheels, a power generation device that generates power, a power transmission device that transmits the generated power to the plurality of wheels, a steering device that steers the direction of the vehicle 300, an acceleration device and a brake device that control the speed, and various devices for the convenience of the passenger).

The vehicle communication circuit 310 supports forming a communication channel of the vehicle 300. The vehicle communication circuit 310 may be configured to communicate with at least one of, for example, the information processing device 100 and the information distribution device 200. For example, the vehicle communication circuit 310 may be configured to form a communication channel with the information distribution device 200 through the base station. The vehicle communication circuit 310 may provide sensing information 331 to the information distribution device 200 in response to the control of the vehicle processor 350. The vehicle communication circuit 310 may receive at least one of road surface information and a warning message from the information distribution device 200 (or the information processing device 100).

The vehicle storage 330 may store various kinds of information required for the operation of the vehicle 300. For example, the vehicle storage 330 may temporarily or semi-permanently store the sensing information 331 related to the utilization of road surface information according to an embodiment of the present invention. The sensing information 331 may include information collected by at least one sensor disposed in the vehicle 300. For example, the sensing information 331 may include at least one of the location information of the vehicle 300, the driving speed and direction information of the vehicle 300, the outside temperature of the vehicle 300, and an image of the road surface in front of the vehicle 300.

The vehicle display 370 may output various screens related to running of the vehicle 300. For example, the vehicle display 370 may output at least some of information related to the current running of the vehicle 300 (e.g., the speed of the vehicle 300, an image of an area around the road on which the vehicle is driving, navigation information, the outside temperature of the vehicle 300, and an image taken outside the vehicle 300). In addition, the vehicle display 370 may output road surface information of the current driving area provided by the information distribution device 200. In addition, when the vehicle 300 receives a warning message, the vehicle display 370 may output the received warning message.

The sensor unit 340 may include at least one of a location detection sensor capable of detecting the location information of the vehicle 300, a lane sensor capable of detecting a change in lane of the vehicle 300, a speed detection sensor capable of detecting the driving speed of the vehicle 300, a direction detection sensor capable of detecting the direction of the vehicle 300, a temperature sensor capable of measuring the outside temperature of the vehicle 300, and an image sensor capable of photographing the road surface in front of the vehicle 300. The sensor unit 340 may be activated in real time or while the vehicle 300 is running to collect sensing information. Alternatively, the sensor unit 340 may be activated upon receiving a request for sensing information collection from the information distribution device 200 when entering a specific area.

The vehicle processor 350 may perform the transmission and reception of information and the transmission and processing of signals in relation to the running of the vehicle 300. In particular, the vehicle processor 350 may include a sensing information collection unit 351, a sensing information transmission unit 353, and an information output unit 355 in relation to the road surface information utilization of the present invention.

The sensing information collection unit 351 may collect sensing information by operating the sensor unit 340 in real time or according to a certain period. Alternatively, the sensing information collection unit 351 may collect sensing information in response to a designated event or reception of a request message. In this process, the sensing information collection unit 351 may collect sensing information by operating at least some of sensors included in the sensor unit 340. The sensing information collection unit 351 may store the collected sensing information 331 in the vehicle storage 330.

The sensing information transmission unit 353 may transmit at least some of the sensing information 331 collected by the sensing information collection unit 351 to the information distribution device 200. In this operation, the sensing information transmission unit 353 may provide the identification information of the vehicle 300 and vehicle-related information (e.g., vehicle type, year, driver-related information, i.e., driving experience, gender, age, etc.) to the information distribution device 200 together with the sensing information 331.

The information output unit 355 may output at least some of road surface information and warning messages received through the vehicle communication circuit 310 to the vehicle display 370. Here, if the received road surface information indicates a normal state of the road surface (e.g., dry state), the information output unit 355 may omit the separate output of road surface information.

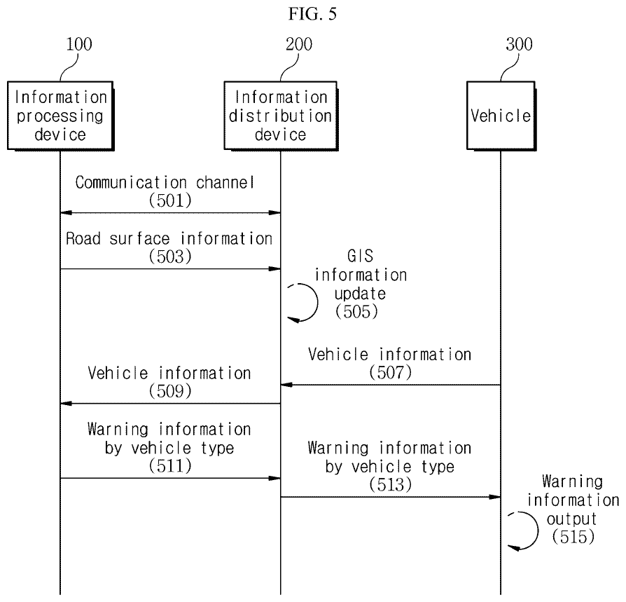

FIG. 5 is a diagram illustrating an example of a signal flow for the operation of an adaptive utilization system of road surface information according to an embodiment of the present invention.

Referring to FIG. 5, in relation to the operation of the adaptive utilization system 10 of road surface information according to the embodiment of the present invention, in step 501, the information processing device 100 and the information distribution device 200 may form a communication channel. The communication channel may be formed at the request of the information distribution device 200 or for the purpose of transmitting road surface information by the information processing device 100. The information processing device 100 may collect road surface detection information of the road 30 using the road surface detection device 50 and determine the road surface state based on the collected road surface detection information. In this regard, the information processing device 100 may collect the road surface detection information and perform a modeling task for generating the road surface determination model 131 in advance, or may receive and store the road surface determination model 131 from a specific external device that provides the road surface determination model 131. The information processing device 100 may collect the road surface detection information according to a designated event (or real-time, at a certain period), and determine whether the road surface state satisfies a predefined condition (e.g., at least one of a freezing state condition, a hydroplaning state condition, a snowfall state condition, a condition in which a pothole or crack of a certain size or larger occur, and a condition in which a foreign substance of a certain size or larger is placed). If the road surface state satisfies the predefined condition, the information processing device 100 may create (or generate) road surface information corresponding to the current road surface state. The above-described road surface state determination may be performed, for example, by analyzing an image of the road surface, or by using at least one of various schemes described above.

In step 503, the information processing device 100 may provide the road surface information to the information distribution device 200. The information distribution device 200 that has received the road surface information may update GIS information in step 505. For example, the information distribution device 200 may identify the location information of an area having a road surface state that satisfies a predetermined condition or more from the road surface information, and update the road surface state of the corresponding location. The information distribution device 200 may transmit the information on the updated road surface state to the vehicle 300 that is driving or is likely to drive in the corresponding area (or location). Meanwhile, in step 507, the vehicle 300 may provide vehicle information to the information distribution device 200. In this regard, the vehicle 300 may operate the sensor unit 340 in real time, periodically, or based on a predetermined condition (e.g., a condition of entering a specific area designated by the information distribution device 200) to collect the sensing information 331. The vehicle 300 may provide the collected sensing information 331 to the information distribution device 200 as vehicle information by including vehicle identification information and vehicle-related information.

In step 509, the information distribution device 200 may transmit at least part of the received vehicle information to the information processing device 100. For example, the information distribution device 200 may provide the information processing device 100 with the vehicle information including at least some of the current location information of the vehicle 300, the vehicle type information of the vehicle 300, the driving speed of the vehicle 300, the outside temperature of the vehicle 300, the road surface image captured by the camera placed in the vehicle 300, the audio signal related to the road surface friction, and the road surface temperature related information. Upon receiving the vehicle information, the information processing device 100 may produce information related to the driving risk of the vehicle 300 based on at least some of the pre-collected road surface detection information and the vehicle information. In an example, the information processing device 100 may determine the road surface state using only the vehicle information and perform vehicle risk level detection in the corresponding road surface state. In this process, the information processing device 100 may produce information on driving risk by vehicle type in the corresponding road surface state and generate warning information (or warning message) by vehicle type based on the produced information.

In step 511, the information processing device 100 may provide the warning information by vehicle to the information distribution device 200. Upon receiving the warning information by vehicle, the information distribution device 200 may provide the warning information by vehicle to the vehicle 300 in step 513. In this process, the information distribution device 200 may identify an area where the road surface state analysis was performed, and provide the warning information by vehicle to the vehicle 300 that will enter the area. Alternatively, the information distribution device 200 may classify warning messages by vehicle type based on vehicle information and transmit different warning messages according to vehicle types.

The vehicle 300 may output the warning information in step 515. For example, the vehicle 300 may output, through the vehicle display 370, a message requesting a reduction in driving speed or a message requesting the turning on of emergency lights. If the vehicle 300 is an autonomous vehicle, the vehicle 300 may gradually reduce its speed to a safe speed required by the warning information in response to the received warning information.

Meanwhile, in the above-described process, if it is determined that the road surface state is normal (e.g., dry) during the vehicle information analysis, the information processing device 100 may omit the separate operation of providing the warning information or provide information indicating that the road surface state is normal to the information distribution device 200.

With respect to the signal flow of the adaptive utilization system of the road surface information according to the present invention described above, steps 501 to 505 and steps 507 to 515 may be operated independently of each other or may be operated simultaneously in parallel.

In an example, the information processing device 100 may determine the road surface state in a specific area (or section) as a road surface state (e.g., freezing state) that satisfies a designated condition, based on the road surface detection information received from the road surface detection devices 50, and may notify it to the information distribution device 200. The information distribution device 200 may provide related area information to the vehicle 300 in advance, and when the vehicle 300 enters the specific area, the vehicle may collect vehicle information (e.g., vehicle location information (or GPS information), rain sensor information, friction, outside temperature) and provide this information to the information distribution device 200, or when the friction is less than a designated reference value, the vehicle may determine it as the occurrence of a friction event and provide the above-described vehicle information to the information distribution device 200. The information distribution device 200 may provide the vehicle information to the information processing device 100, and the information processing device 100 may perform deep-learning analysis and anomaly detection (AD) modeling on road surface determination by vehicle type (e.g., derivation of criteria for vehicle information in case of road surface freezing-modeling capable of determining a freezing warning when the friction of a specific vehicle type is below a certain reference value and the outside temperature is below a certain reference value) and provide the result to the information distribution device 200. The information distribution device 200 may load such modeling by vehicle type and then classify and distribute it by vehicle type of the vehicle 300. If the friction event occurs in a specific vehicle 300, it may be checked whether it meets a freezing condition, and if it does, the vehicle 300 alone may determine it as a road surface freezing. Alternatively, the vehicle 300 may generate information on freezing and provide it to the information distribution device 200, and the information distribution device 200 may apply road information including an infrastructure deficient section to GIS information.

Meanwhile, although it is described above that the information processing device and the information distribution device are distinguished as separate components and their respective roles are different, the present invention is not limited thereto. For example, at least some functions of the information processing device described above may be performed by the information distribution device, or at least some functions of the information distribution device may be performed by the information processing device. Accordingly, the information processing device and the information distribution device may be implemented as a single integrated device. Alternatively, the information processing device and the information distribution device may be decomposed into functional modules or functional hardware devices according to their respective functions, and the decomposed hardware devices supporting the respective function may be configured to communicate with each other and perform operations necessary for the adaptive utilization of the road surface information of the present invention. Therefore, although the specific function and operation have been described as being performed in the information processing device or the information distribution device as an example, the function and operation may be performed in different hardware devices or may be performed by adding a new hardware device.

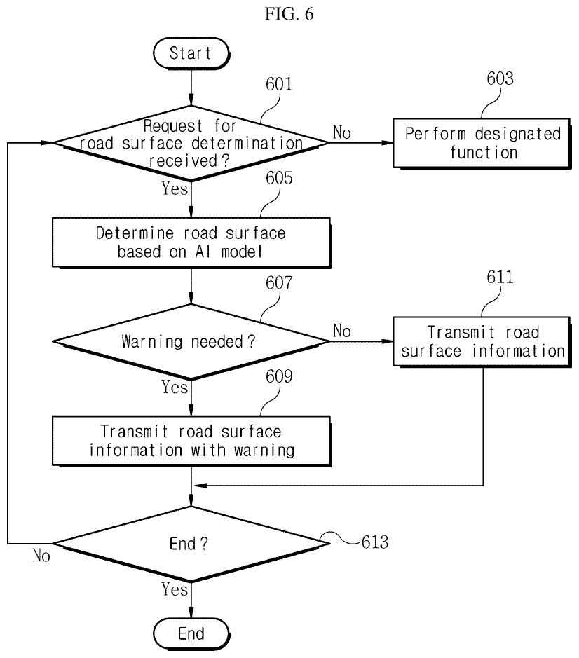

FIG. 6 is a diagram illustrating an example of an information processing device operation method in an adaptive utilization method of road surface information according to an embodiment of the present invention.

Referring to FIG. 6, in a method for operating the information processing device in relation to the adaptive utilization of road surface information according to the embodiment of the present invention, the information processing processor 150 of the information processing device 100 may check in step 601 whether a request for road surface determination is received. If the request for road surface determination is not received, the information processing processor 150 may perform a designated function in step 603. Receiving the request for road surface determination may include, for example, a state in which the information processing device 100 receives a road surface determination request message from the information distribution device 200. Or, receiving the request for road surface determination may include a situation in which the weather conditions of at least one area where the road surface detection device 50 is disposed are changed or the weather conditions exceed a predefined condition. In this regard, the information processing device 100 may collect in real time weather information of various areas where the vehicle 300 can drive, and when the weather conditions change by a predetermined size or more or when the weather conditions exceed a predetermined condition, it may determine that the road surface determination request is received. Or, the information processing device 100 may proceed with a procedure for road surface determination based on an administrator's input. In various examples, the information processing processor 150 may receive the request for road surface determination from the vehicle 300 entering an area with pre-designated conditions (e.g., an infrastructure deficient section). In this regard, the vehicle 300 may receive information about the location of the infrastructure deficient section in advance from the information distribution device 200 and store it. If no road surface determination request is received, the information processing device 100 may monitor real-time weather conditions.

When the request for road surface determination is received, in step 605, the information processing processor 150 of the information processing device 100 may perform AI model-based road surface determination. In this regard, the information processing device 100 may pre-store the road surface determination model 131 for road surface determination. The road surface determination model 131 may include at least one model capable of determining various road surface states. The road surface determination model 131 may include a vehicle risk level detection model regarding the risk of vehicle driving that may occur depending on the road surface state.

In step 607, the information processing processor 150 of the information processing device 100 may determine whether a warning is needed. For example, the information processing processor 150 may determine that a warning is needed if the road surface state is a predefined state (e.g., a freezing state, a hydroplaning state, a snowfall state, a state where a pothole or crack of a certain size or larger occurs, a state where a foreign substance of a certain size or larger is placed on the road 30). Or, the information processing processor 150 may determine that a warning is needed if the driving risk level of a vehicle type of the vehicle 300 currently entering an area with a specific road surface state is higher than a certain reference value based on the vehicle risk level detection model. The driving risk level may be generated based on, for example, experimental data and statistical data according to driving at various driving speeds on various road surface states for various vehicle types. Such driving risk levels may be provided to the information processing device 100 by a specific external electronic device (e.g., an electronic device operated by a vehicle manufacturer that detects the risk level by vehicle type and road surface state).

If it is determined that a warning is needed, the information processing processor 150 of the information processing device 100 may process the transmission of road surface information including a warning in step 609. This warning message may include a speed limit range for guiding safe driving of the corresponding vehicle type.

If it is determined that a warning is not needed, the information processing processor 150 of the information processing device 100 may process the transmission of road surface information in step 611. The road surface information may include, for example, information indicating a normal state. In steps 609 and 611, the information processing processor 150 may transmit the corresponding road surface information to the information distribution device 200 or directly to a vehicle entering the corresponding area.

In step 613, the information processing processor 150 of the information processing device 100 may check whether an event related to function termination has occurred, and if there is no function termination event, it may return to step 601 and re-perform the subsequent operations. When a function termination event occurs, it may terminate the road information determination and information provision function. After termination, the information processing device 100 may have a standby state in which it waits for reception of a road surface determination request.

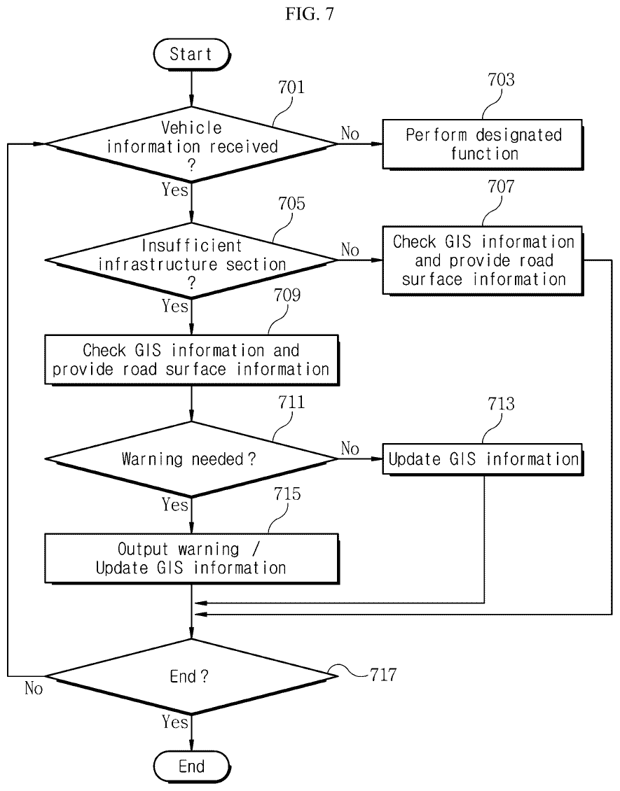

FIG. 7 is a diagram illustrating an example of an information distribution device operation method in an adaptive utilization method of road surface information according to an embodiment of the present invention.

Referring to FIG. 7, in a method for operating the information distribution device in relation to the adaptive utilization of road surface information according to the embodiment of the present invention, the server processor 250 of the information distribution device 200 may check in step 701 whether vehicle information is received. In relation to the reception of vehicle information, an administrator of the information distribution device 200 may construct a communication infrastructure capable of receiving vehicle information from the vehicle 300 by area, section, or road. Or, the information distribution device 200 may construct a communication infrastructure capable of collecting vehicle information through a base station of a communication service provider (or a mobile communication service provider, an operator of the information processing device 100 of the present invention) that operates a plurality of base stations. The vehicle information reception may be performed in real time or periodically. Or, the vehicle information may be set to be received from the vehicle 300 according to the occurrence of a specific event (e.g., a change in weather conditions or an occurrence of a situation that causes a change in the road surface state) by area or section. Or, the vehicle information may be received from at least one vehicle pre-designated by the information distribution device 200.

If there is no vehicle information reception, the server processor 250 may perform a designated function in step 703. For example, the server processor 250 may collect standardized road surface information from various departments or ministries that collect and operate road surface information through a standardized communication protocol, and support identifying the road surface state for each road by applying the collected road surface information to GIS information.

When the vehicle information is received, in step 705, the server processor 250 may identify the location (or area) of the provided vehicle information and identify whether the location is an infrastructure deficient section. Whether the location is an infrastructure deficient section may be determined based on information collected in advance. In this regard, the information distribution device 200 may collect information in advance on whether a road surface detection device capable of determining the road surface state of roads included in GIS information is installed, and record this in the GIS information. The infrastructure deficient section may include a case where a certain number of the above-described road surface detection devices or more are not installed or the resolution of information collected by the road surface detection device is lower than a reference value. Or, the information distribution device 200 may determine a section (or zone, area) where road surface detection information is not provided from the road surface detection device as the infrastructure deficient section. Or, the information distribution device 200 may set a road section that is not covered by the road surface information provided from various departments or ministries as the infrastructure deficient section.

If it is not an infrastructure deficient section, if it is a section where infrastructure is sufficient, or if it is a section where there is road surface detection information necessary for detecting road surface states, the server processor 250 may check GIS information and provide road surface information in step 707. For example, from road surface detection information collected by the road surface detection device 50 without vehicle information, it may check whether the vehicle 300 is located in a section where road surface information is generated, check the GIS information of the area where the vehicle 300 is located, produce road surface information corresponding to the area from the road surface DB 233, and provide it to the vehicle 300.

If it is an infrastructure deficient section, the server processor 250 may receive road surface information after transmitting vehicle information to the information processing device 100 in step 709. In this process, the information processing device 100 receiving the vehicle information may perform steps 601 to 613 described above in FIG. 6 to determine a road surface state, generate road surface information based on the determined road surface state, and determine whether to create a warning message for the vehicle upon generating the road surface information.

When the road surface information is received, the server processor 250 may check in step 711 whether the road surface information requires a warning to the vehicle 300. In this regard, the server processor 250 may check whether the road surface information includes a warning message. Meanwhile, the information processing device 100 may be configured to provide only the road surface information corresponding to the road surface state, and the information distribution device 200 may be configured to determine whether to create a warning message by road surface state and vehicle type. In this case, if the current road surface state determined based on the vehicle information requires a warning message, the server processor 250 may create the warning message for the corresponding vehicle 300.

If a warning is not needed, the server processor 250 may update GIS information in step 713. For example, based on the road surface state included in the road surface information and the area information having the corresponding road surface state, the server processor 250 may update the GIS information.

If a warning is needed, the server processor 250 may process a warning output and update the GIS information in step 715. In relation to the warning output, the server processor 250 may form a communication channel with the vehicle 300 that provided the vehicle information, and provide the vehicle 300 with a warning message for guiding the safe driving of the vehicle 300. In addition, the server processor 250 may apply and update the history of sending the warning message to the vehicle 300 and the corresponding road surface state to the GIS information. Additionally or alternatively, the information distribution device 200 may broadcast the related warning message to other vehicles within a certain range of the road on which the vehicle 300 to which the warning message is sent is driving.

In step 717, the server processor 250 may check the occurrence of an event requesting the termination of a function related to road surface determination and warning. If the corresponding event does not occur, the server processor 250 may return to step 701 and re-perform the subsequent operations. If a termination request event occurs, the server processor 250 may terminate the function.

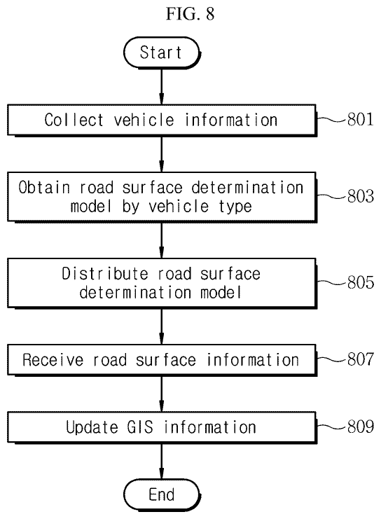

FIG. 8 is a diagram illustrating another example of an information distribution device operation method in an adaptive utilization method of road surface information according to an embodiment of the present invention.

Referring to FIG. 8, in relation to the operation of the information distribution device 200 in relation to the adaptive utilization of road surface information according to the embodiment of the present invention, the server processor 250 may collect vehicle information including the outside temperature of the vehicle and the friction value of the wheel on the road surface in step 801. In relation to this, the server processor 250 may form a communication channel with at least one vehicle 300 and collect the vehicle information from the vehicle 300.

In step 803, the server processor may obtain road surface determination model by vehicle type based on the vehicle information. In relation to this, the server processor 250 may provide the vehicle information to the information processing device 100 and receive the road surface determination models by vehicle type from the information processing device 100. Or, the information distribution device 200 may perform road surface determination modeling by vehicle type.

In step 805, the server processor 250 may distribute the road surface determination models by vehicle type to respective vehicles by vehicle type. In this regard, the server processor 250 may classify the vehicles 300 by vehicle type and distribute the road surface determination models to the classified vehicles.

In step 807, the server processor 250 may receive the road surface information determined based on the road surface determination model by vehicle type from the vehicle driving on the road. The vehicle 300 may determine the road surface state by applying the currently collected vehicle information to the previously stored road surface determination model in real time, at a certain period, or upon entering a specific area (e.g., an infrastructure deficient section), create road surface information, and provide it to the information distribution device 200.

In step 809, the server processor 250 may apply the road surface information received from the vehicles 300 to GIS information. In this process, the server processor 250 may provide the updated GIS information to all vehicles 300 or provide it distinctively by vehicle type. In addition, the server processor 250 may create GIS information in which dangerous sections are recorded differently for each vehicle type, create GIS information by vehicle type, and distribute it distinctively by vehicle type.

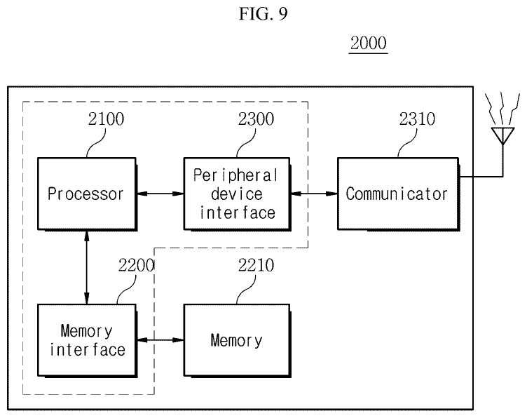

FIG. 9 is an example diagram of a hardware system for implementing a device for adaptive utilization of road surface information according to an embodiment of the present invention.

As shown in FIG. 9, the hardware system 2000 according to an embodiment of the present invention may include a processor 2100, a memory interface 2200, and a peripheral device interface 2300.

These respective elements in the hardware system 2000 may be individual components or be integrated into one or more integrated circuits and may be combined by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

Here, the respective components including the learning unit 151, the road surface determination unit 153, and the information generation unit 155 described with reference to FIG. 2, the information collection unit 251, the information provision unit 253, the information update unit 255, and the information transmission unit 257 described with reference to FIG. 3, or the sensing information collection unit 351, the sensing information transmission unit 353, and the information output unit 355 described with reference to FIG. 4 may be stored in the form of software modules, and the operating system (OS) may be additionally stored. Such components including the learning unit 151, the road surface determination unit 153, and the information generation unit 155 described with reference to FIG. 2, the information collection unit 251, the information provision unit 253, the information update unit 255, and the information transmission unit 257 described with reference to FIG. 3, or the sensing information collection unit 351, the sensing information transmission unit 353, and the information output unit 355 described with reference to FIG. 4 may be loaded onto and executed by the processor 2100.

The respective components including the learning unit 151, the road surface determination unit 153, and the information generation unit 155 described with reference to FIG. 2, the information collection unit 251, the information provision unit 253, the information update unit 255, and the information transmission unit 257 described with reference to FIG. 3, or the sensing information collection unit 351, the sensing information transmission unit 353, and the information output unit 355 described with reference to FIG. 4 may be implemented in the form of software modules or hardware modules executed by a processor, or may also be implemented in the form of a combination of software modules and hardware modules.

Such software modules, hardware modules, or a combination thereof, executed by a processor, may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but is not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices.

The peripheral devices are to provide different functions to the hardware system 2000, and in one embodiment of the present invention, a communicator 2310 may be included, for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to an embodiment of the present invention, each component stored in the memory 2210 in the form of a software module performs an interface with the communicator 2310 via the memory interface 2200 and the peripheral device interface 2300 in the form of a command executed by the processor 2100.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The present invention relates to a method for adaptively utilizing road surface information. The present invention supports standardized information collection and utilization, enables road surface states to be identified by distinguishing between a section with sufficient infrastructure and a section with insufficient infrastructure, and provides information on dangerous driving sections by vehicle type, thereby supporting safe vehicle operation. In addition, the present invention collects, classifies, and distributes results of road surface state analysis by vehicle type, thereby supporting effective information use suitable for the vehicle type. Therefore, the present invention has industrial applicability because it not only has sufficient marketability or commercial viability but also can be realistically and clearly implemented.

Specific embodiments of the subject matter have been described in the disclosure. Other embodiments are within the scope of the following claims. For example, the operations recited in the claims can be performed in a different order and still achieve desirable results. As an example, the process depicted in the accompanying drawings does not necessarily require the depicted order or sequential order to achieve desirable results. In certain implementations, multitasking and parallel processing may be advantageous.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

### LIST OF REFERENCE NUMERALS

10: Adaptive utilization system of road surface information
30: Road
100: Information processing device
200: Information distribution device
300: Vehicle

What is claimed is:

1. A method for adaptive utilization of road surface information, the method comprising:
at a server processor of an information distribution device, collecting vehicle information including vehicle outside temperature and friction value of wheels on a road surface;
at the server processor, obtaining a road surface determination model by vehicle type based on the vehicle information;
at the server processor, distributing the road surface determination model by vehicle type to each vehicle by vehicle type;
at the server processor, receiving road surface information determined based on the road surface determination model by vehicle type from a vehicle driving on a road; and
at the server processor, applying the road surface information to geographic information system (GIS) information.

2. The method of claim 1, further comprising:
at the server processor, identifying a current location of the vehicle after receiving the road surface information; and
in case that the current location of the vehicle is in a pre-designated infrastructure deficient section, applying the road surface information to the GIS information.

3. The method of claim 1, wherein obtaining includes:
providing the vehicle information to an information processing device; and
receiving the road surface determination model by vehicle type generated by the information processing device based on the vehicle information.

4. The method of claim 1, wherein applying the road surface information to the GIS information includes:
at the server processor, generating the GIS information in which a dangerous section is applied differently by vehicle type.

5. The method of claim 4, further comprising:
at the server processor, distributing the GIS information with the dangerous section applied differently by vehicle type to each vehicle type differently.

6. An information distribution device for supporting adaptive utilization of road surface information, the device comprising:
a server communication circuit forming a communication channel with at least one vehicle; and
a server processor functionally connected to the server communication circuit,
the server processor configured to:
distribute road surface determination models by vehicle type differently to each vehicle by vehicle type, the road surface determination model by vehicle type allowing a road surface state to be determined according to vehicle type based on vehicle information including at least one of vehicle outside temperature and friction value of wheels on a road surface, and
upon receiving road surface information determined based on the road surface determination model by vehicle type from a vehicle currently driving on a road, apply the road surface information to geographic information system (GIS) information.

7. The device of claim 6, wherein the server processor is configured to:
provide the vehicle information to an information processing device, and receive the road surface determination models by vehicle type generated based on the vehicle information from the information processing device.

8. The device of claim 6, wherein the server processor is configured to:
receive current location information of the vehicle that provides the road surface information,
in case that a current location of the vehicle is in a pre-designated infrastructure deficient section, apply the road surface information provided by the vehicle to the GIS information, and
in case that the current location of the vehicle is in a pre-designated infrastructure sufficient section, update the GIS information by referring to the road surface information provided by the vehicle based on the pre-stored road surface information.

9. The device of claim 6, wherein the server processor is configured to:
generate the GIS information in which a dangerous section is indicated differently by vehicle type, based on the road surface information.

10. The device of claim 9, wherein the server processor is configured to:
distribute the GIS information with the dangerous section applied differently by vehicle type to the vehicle differently by vehicle type.

11. An information processing device for supporting adaptive utilization of road surface information, the device comprising:
a communication circuit; and
a processor,
the processor configured to:
for a pre-designated infrastructure deficient section where an amount of road surface detection information collected about a road is not greater than a preset reference, collect vehicle information from vehicles driving in the infrastructure deficient section,
determine a road surface state of the infrastructure deficient section based on the collected vehicle information,
detect a driving risk level by vehicle type in the determined road surface state,
generate a warning message for safe driving based on the detected driving risk level by vehicle type, and
transmit the warning message and road surface information including the road surface state to the vehicle.

12. A system for adaptive utilization of road surface information, the system comprising:
an information distribution device that collects vehicle information from vehicles driving in a pre-designated infrastructure deficient section where an amount of road surface detection information collected about a road is not greater than a preset reference; and
an information processing device that determines a road surface state of the infrastructure deficient section based on the vehicle information provided by the information distribution device, detects a driving risk level by vehicle type in the determined road surface state, generates a warning message for safe driving based on the detected driving risk level by vehicle type, and provides the warning message and road surface information including the road surface state to the vehicle via the information distribution device.
